(19) United States
(12) Patent Application Publication
(10) Pub. No.: US 2007/0052714 A1
(43) Pub. Date: Mar. 8, 2007

(54) Video processing system

(75) Inventors: Chuen-She Chen, Taipei Hsien (TW); Shih-Chieh Yen, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Aten International Co., Ltd.

(21) Appl. No.: 11/435,639

(22) Filed: May 17, 2006

(30) Foreign Application Priority Data
Jun. 30, 2005 (TW) 94122179

(51) Int. Cl. G06F 15/167

(52) U.S. Cl. 345/541

(57) ABSTRACT

The present invention provides a video processing system including a plurality of buses, a plurality of codecs and a plurality of memories. The buses provide different access routes. The processed video data and the original video data are stored in different memories through different access routes. The video data of same pictures may be divided into a plurality of parts for processing by different codecs respectively.

### RELATED APPLICATIONS

The present application is based on, and claims priority from, Taiwan Application Serial Number 94122179, filed Jun. 30, 2005, the disclosure of which is hereby incorporated by reference herein in its entirety.

### FIELD OF THE INVENTION

The present invention is about a processing system, and more particularly, is about a video processing system.

### BACKGROUND OF THE INVENTION

Video transmitting is very important today. However, video always needs a lot of storage space and transmitting resources for processing. For reducing the loading when transmitting video data, compression of the video data is performed first to reduce the data amount for improving the transmitting efficiency. The typical compressing technologies for static images include JPEG, GIF, Half-tone and so on, and for dynamic images includes MPEG-2, MPEG-4, WMV and so on.

FIG. 1 illustrates a typical system for transmitting and receiving video data. This system is connected to the Internet through an Internet controller 104. When transmitting video data, a capture 101 is used to get the video data from a computer 102. The captured video data is transmitted to a codec 107 for compressing through a bus 100. Then, the compressed data is transmitted to a memory controller 106 through the bus 100 for storing the data to a memory 108. Finally, the CPU 103 may control the compressed data sent out through the Internet.

After receiving video data sent through the Internet, the data is decoded by a decoder 107 first. Then, the decoded video data is transmitted to the memory controller 106 through the bus 100 for storing in the memory 108. The display controller 105 may read the data in the memory 108 to display in the LCD 109.

However, there are many drawbacks in the typical transmitting and receiving video data system. For example, it is impossible to real-time decode/encode high-resolution video data by a single codec. Moreover, the decoded/encoded video data and the other data are stored in a same memory. When the bandwidth to access data from the memory is not high enough, the computer efficiency is reduced. Moreover, in the typical system, a single bus is responsible for transmitting all data, which limits the bandwidth for transmitting video data. Therefore, the video data transmitting efficiency is also limited.

Therefore, a system that can resolve the foregoing problems and still process high-resolution video data is required.

### SUMMARY OF THE INVENTION

Therefore, the purpose of the present invention is to provide a video data processing system to resolve the problem of insufficient bandwidth.

The other purpose of the present invention is to provide a video data processing system for real-time decoding and encoding the received video data.

Accordingly, the video data processing system of the present invention includes a plurality of buses, a plurality of codecs and a plurality of memories. The buses provide different access routes. The compressed video data and the original video data are stored in different memories through different access routes to avoid the video delay phenomenon due to the conflict of access routes. The video data of same pictures may be divided into a plurality of parts for processing by different codecs to reduce the loading of each codec. Therefore, the video processing speed may be increased.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a typical system for transmitting and receiving video data;

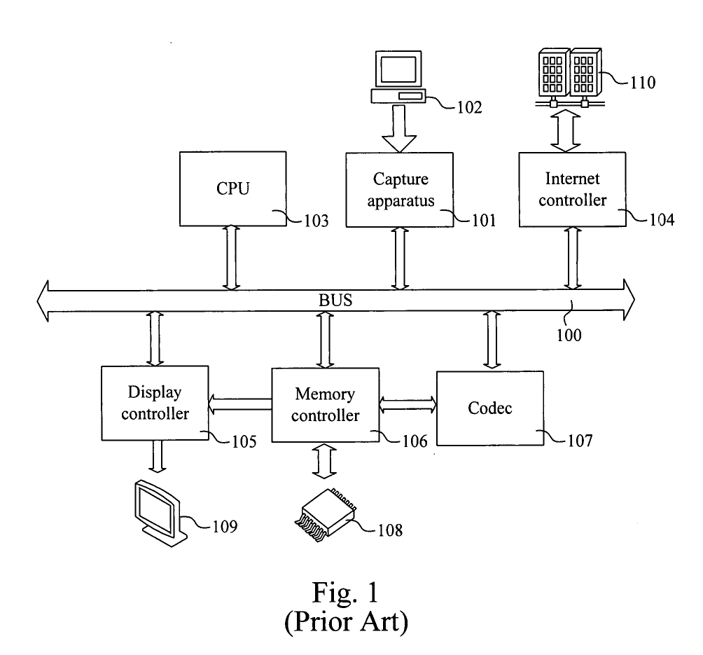

FIG. 2 illustrates a system for transmitting and receiving video data according to the present invention;

FIG. 3A illustrates a schematic diagram of using the system of the present invention to encode video data; and

FIG. 3B illustrates a schematic diagram of using the system of the present invention to decode video data.

### DETAILED DESCRIPTION OF THE PREFERRED EMBODIMENT

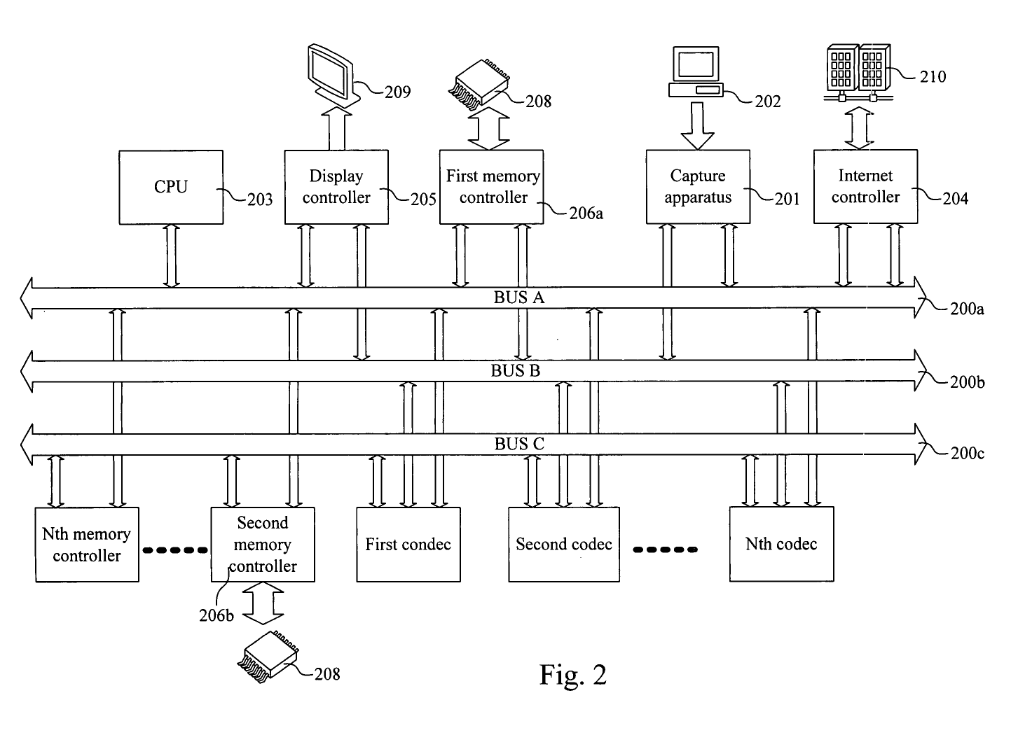

FIG. 2 illustrates a system for transmitting and receiving video data according to the present invention. For resolving the problems of insufficient bandwidth and the conflict among buses so as to increase the processing speed, the system described in the following is adapted.

In the present invention, at least three buses, including a first bus 200a, a second bus 200b and a third bus 200c, are used to connect all devices in the system. Moreover, a plurality of codecs, including a first codec through the Nth codec, is responsible for decoding/encoding the video data in this system. At least two memory controllers, such as a first memory controller 206a and a second memory controller 206b, are used to control at least two storage means, such as a first memory 208a and a second memory 208b, for storing the video data and the other data respectively. In addition, an Internet controller 204, such as an Ethernet controller, is used to connect with the Internet. The capture apparatus 201 may capture the data of a picture shown in the computer 202. The CPU 203 may control the transmitting or receiving of video data. The display controller 205, such as an LCD display controller, is responsible for displaying the video in a display, such as a liquid crystal display.

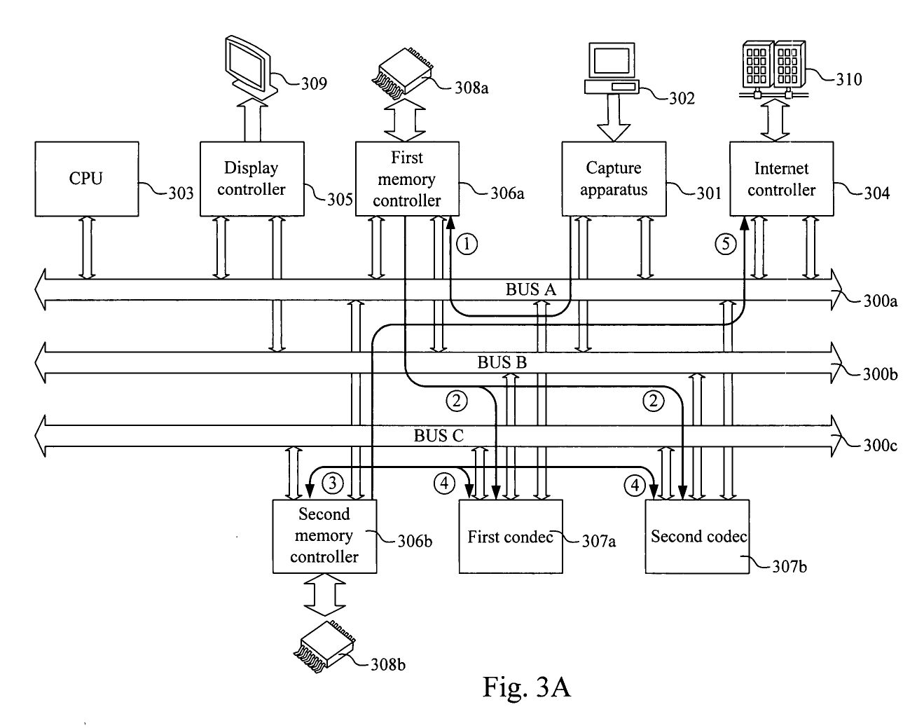

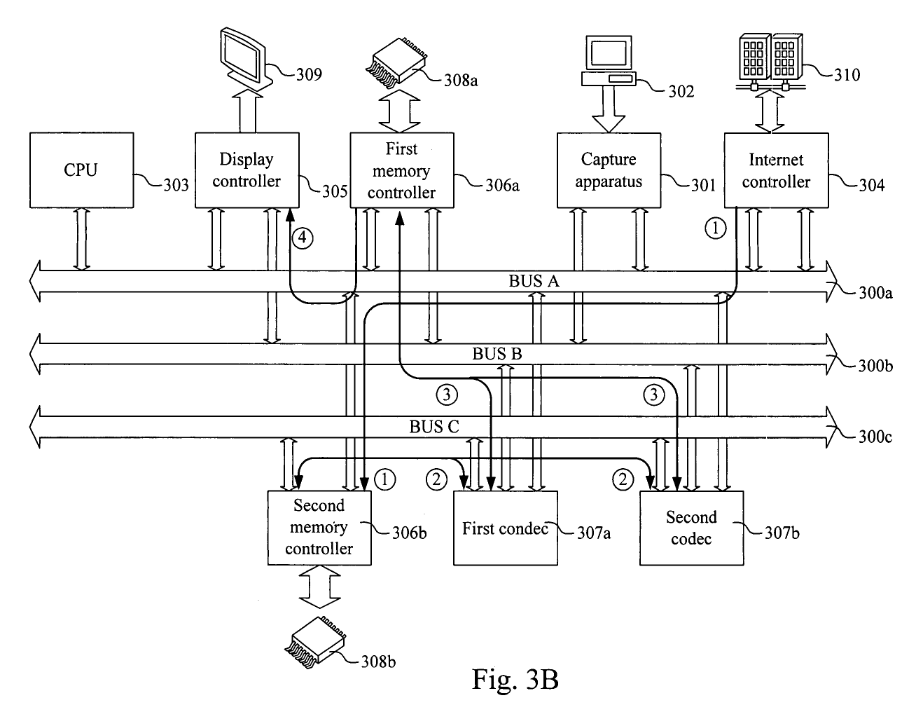

FIG. 3A illustrates a schematic diagram of using the system of the present invention to encode data. The system according to the embodiment includes three buses 300a, 300b and 300c to connect all the peripheral devices. A first codecs 307a and a second 307b are responsible for decoding or encoding the video data. Two memory controllers, including first memory controller 306a and second memory controller 306b, are responsible for controlling a first memory 308a and a second memory 308b to store the original video data and the processed video data, respectively. The first memory 308a is coupled to the bus 300a and the bus 300b through the first memory controller 306a. The second memory 308b is coupled to the bus 300a and the bus 300c through the second memory controller 306b. The capture apparatus 301 is coupled to the bus 300a and the bus 300b. The display controller 305 is coupled to the bus 300a and the bus 300b.

According to this embodiment, when original video data to be encoded from the Internet or from a capture apparatus 301, the video data is sent to the first memory controller 306a through the bus 300a (route 1) to store in a first memory 308a. Then, the codecs 307a and 307b may take out the stored original data from the first memory 308a for encoding the video data through bus 300b (route 2). The video data processing speed may be increased in the present invention due to using two codecs 307a and 307b for processing data. According to an embodiment of the present invention, a picture (constituted by original video data) can be divided into two parts. Then, the first codec 307a and the second codec 307b encode the different parts of the picture, respectively and simultaneously.

The encoded video data is sent to the second memory controller 306b through bus 300c (route 3) to store in the second memory 308b. In the present invention, the processed video data and the original video data are respectively stored in the second memory 308b and the first memory 308a which can avoid the conflict of the routes when the second memory 308b and accessing the second memory 308b are accessed. Moreover, during the encoding process, the video data of each picture can be compared with the video data of the immediately preceding picture to realize motion estimation functionality. Finally, the CPU 303 may send the video data in the second memory 308b to the Internet controller 304 coupled to the bus 300a for uploading the encoded data to the Internet through the route 5.

FIG. 3B illustrates a schematic diagram of using the system of the present invention to decode the video data. According to the embodiment, when decoding encoded video data from the Internet 310, the encoded video data is sent to the second memory controller 306b through the bus 300a (route 1) to store in the second memory 308b. Then, the codecs 307a and 307b may take out the stored encoded data from the second memory 308b for decoding the video data through bus 300c (route 2). Similarly, in the present invention, the video data decoding processing speed may be increased due to using two codecs 307a and 307b for decoding data.

The decoded video data is sent to the first memory controller 306a through bus 300b (route 3) to store in the first memory 308a. Finally, the CPU 303 may send the decoded video data in the first memory 308a to the display controller 305 coupled to the bus 300a and bus 300b for displaying in the LCD 309 through the bus 300b (route 4).

According to this embodiment, the decoded video data is stored in the first memory 308a and the encoded data is stored in the second memory 308b. Therefore, when displaying the decoded video data, the data is accessed from the first memory 308a through the bus 300b (route 4 in the FIG. 3b). On the other hand, the encoded video data is stored into the second memory 308b through the bus 300c (route 3 in the FIG. 3a). In other words, there are two different routes responsible for accessing the decoded video data and the encoded video data, which can avoid the conflict between routes and improve the smoothness of displaying video.

It is noticed that the foregoing is one of the preferred embodiments. In other embodiments, the connection relationship between peripheral devices, such as the memory controller, capture apparatus or Internet controller, and buses is changeable according to the design. In addition, for improving the video processing speed, the number of the codecs may be increased for processing a same picture at the same time. In other words, a picture can be divided into several parts and each part is processed by a codec. Such structure may reduce the loading of each codec so as to increase the processing video speed.

Accordingly, the present invention provides a video processing system including a plurality of buses, a plurality of codecs and a plurality of memories. According to the system, a picture can be divided into several parts and each part is processed by a codec so as to reduce the loading of each codec to increase the processing video speed. In addition, the decoded video data and the encoded video data are stored in different memories through different access routes. Therefore, the video delay phenomenon due to the conflict of access routes can be avoided. Moreover, the accessing conflict of the CPU and the codec are also avoided in the system.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A video processing system, comprising:
at least three buses for providing different access routes;
at least two codecs coupled with said buses for encoding original video data or decoding encoded video data; and
at least two memories, including a first memory and a second memory, coupled with a part of said buses, wherein said first memory stores said original video data and decoded video data, and said second memory stores said encoded video data.

2. The system according to claim 1, wherein said original video data and said decoded video data are stored into said first memory through a same bus.

3. The system according to claim 1, wherein said decoded video data and said encoded video data are stored into said first memory and said second memory respectively through different buses.

4. The system according to claim 1, further comprising two memory controllers for controlling said first memory and said second memory respectively.

5. The system according to claim 1, further comprising an Internet controller coupled with a part of said buses to connect with the Internet for uploading or receiving an encoded video data.

6. The system according to claim 5, wherein said uploading or receiving an encoded video data is performed in a same bus.

7. The system according to claim 1, further comprising a capture apparatus coupled with a part of said buses for capturing a video data to store into said first memory.

8. The system according to claim 1, further comprising a display controller coupled with a part of said buses for accessing said decoded video data from said first memory.

9. The system according to claim 1, wherein storing said decoded video data into said first memory and accessing said decoded video data from said first memory are performed in different buses.

10. A video processing system for transforming a first video data to a second video data, comprising:
a processor;
a first encoder;
a second encoder;
a first storage means;
a second storage means;
a first bus coupled with said processor, said first encoder, said second encoder, said first storage means and said second storage means;
a second bus coupled with said processor, said first encoder, said second encoder and said first storage means; and
a third bus coupled with said first encoder, said second encoder, said first storage means and said second storage means;
wherein said processor stores said first video data into said first storage means through said first bus, said first encoder and said second encoder encode said first video data to said second video data through said second bus, and said processor stores said second video data into said second storage means through said third bus.

11. The system according to claim 10, further comprising an Internet controller, and said processor moves said second video data to said Internet controller through said first bus.

12. The system according to claim 10, further comprising:
a first controller to control said first storage means; and
a second controller to control said second storage means.

13. The system according to claim 10, further comprising a capture apparatus for capturing said first video data.

14. A video processing system for transforming a first video data to a second video data, comprising:
a processor;
a first decoder;
a second decoder;
a first storage means;
a second storage means;
a first bus coupled with said processor, said first decoder, said second decoder, said first storage means and said second storage means;
a second bus coupled with said processor, said first decoder, said second decoder and said first storage means; and
a third bus coupled with said first decoder, said second decoder, said first storage means and said second storage means;
wherein said processor stores said first video data into said second storage means through said first bus, said first decoder and said second decoder decode said first video data to said second video data through said third bus, and said processor stores said second video data into said first storage means through said second bus.

15. The system according to claim 14, further comprising an Internet controller, and said Internet controller gets said first video data through an Internet.

16. The system according to claim 14, further comprising:
a first controller to control said first storage means; and
a second controller to control said second storage means.
